(19) United States
(12) Patent Application Publication
(10) Pub. No.: US 2010/0115552 A1
(43) Pub. Date: May 6, 2010

(54) Method and apparatus for receiving electronic service guide by mobile communication terminal in digital video broadcasting-handheld system

(75) Inventors: Hyung-Il Lee, Yongin-si (KR); Young-Jip Kim, Suwon-si (KR); Byoung-Dai Lee, Seongnam-si (KR); Chang-Hyeon Lim, Seoul (KR); Young-Jin Choi, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/586,004

(22) Filed: Sep. 16, 2009

(30) Foreign Application Priority Data
Nov. 5, 2008 (KR) 10-2008-0109349

(51) Int. Cl. H04N 5/445; H04M 1/00; H04N 7/16

(52) U.S. Cl. 725/39; 455/556.1; 725/62

(57) ABSTRACT

A method and apparatus is provided for receiving an Electronic Service Guide (ESG) by a mobile communication terminal in a Digital Video Broadcasting-Handheld (DVB-H) system including a service provider providing a broadcast service and the mobile communication terminal receiving the broadcast service from the service provider. Upon receipt of a broadcast service request, the mobile communication terminal determines whether a first ESG about the broadcast service has been stored. When the first ESG has been stored, the mobile communication terminal requests the service provider to first transmit broadcast data among a second ESG and the broadcast data contained in the broadcast service, based on the first ESG. The mobile communication terminal receives the broadcast data first from the service provider and displays the received broadcast data.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Nov. 5, 2008 and assigned Serial No. 10-2008-109349, the entire disclosure of which is hereby incorporated by reference.

### TECHNICAL FIELD OF THE INVENTION

The present invention relates to a method and apparatus for receiving an Electronic Service Guide (ESG) by a mobile communication terminal in a Digital Video Broadcasting-Handheld (DVB-H) system. More particularly, the present invention relates to an ESG reception method and apparatus for reducing awaiting time before displaying broadcast data by a mobile communication terminal to serve user's convenience in a DVB-H system.

### BACKGROUND OF THE INVENTION

DVB-H is a technology standard established in Europe to improve a rate of receiving terrestrial Digital Television (DTV) while on the move. This technology realizes mobile multimedia broadcasting that offers high-quality audio and video services anytime, anyplace, even while a user is driving a car or walking about.

Service models using DVB-H may be configured as follows. A transmission entity is made up of a network over which broadcasters and common carriers interwork with one another in accordance with a DVB-Universal Mobile Telecommunication System (UMTS) standard. The broadcasters transmit compressed data to mobile communication terminals by DVB-H transmission, based on a DVB-Audio Visual Content (AVC) standard. Then the mobile communication terminals communicate again with the common carriers using a communication standard such as DVB-UMTS/Global System for Mobile (GSM) communication, and deliver information about the reception entity even to the broadcasters over the communication network in real time.

In DVB-H, broadcast-related information is mostly contained in an ESG. With use of ESG, a user may select an interested TV channel or radio channel, or select items that he or she intends to download. In addition, ESG provides information based on which mobile communication terminals can access specific Internet Protocol (IP) streams in a DVB-H Transport Stream. A process of handling the ESG can be divided into three sub processes: an ESG Bootstrapping process, an ESG Acquisition process and an ESG Update process.

To be specific, in the ESG Bootstrapping process, a mobile communication terminal determines types of ESGs that the mobile communication terminal can receive, and also determines how the mobile communication terminal can obtain them. In the ESG Acquisition process, the mobile communication terminal gathers and handles ESG data. In the ESG Update process, the mobile communication terminal updates ESG information of the latest version.

FIG. 1 illustrates a method for receiving ESG data by a mobile communication terminal according to the prior art.

In step S10, a mobile communication terminal scans frequencies and accesses a frequency channel carrying a broadcast service. At this point, the mobile communication terminal may sense a user input selecting a frequency channel over which the user intends to receive a broadcast service.

When a frequency channel is selected, the mobile communication terminal requests a service provider to send the broadcast service in step S12. The mobile communication terminal receives a bootstrap session from the service provider in step S14, and then receives ESG data in step S16. Based on the received bootstrap session, the mobile communication terminal may determine types of available ESGs and also determine how it can obtain them.

As the mobile communication terminal receives the ESG data, the user may acquire information about the broadcast that he or she can receive from the service provider. The user can select and replay desired broadcast data in the acquired information. In step S18, the mobile communication terminal requests the service provider to send broadcast data corresponding to the channel selected by the user. In step S20, the mobile communication terminal receives the broadcast data from the service provider and plays it back.

However, the mobile communication terminal cannot receive the broadcast service from the service provider unless it always receives ESG data. In transmitting ESG data, the DVB-H standard transmits a considerable amount of supplementary data in addition to the basic data necessarily required to receive actual broadcast service. As a result, the conventional reception method of the mobile communication terminal may decrease in efficiency, and increase in waiting time for which the user waits in order to play back the desired broadcast data.

### SUMMARY OF THE INVENTION

To address the above-discussed deficiencies of the prior art, it is a primary aspect of the present invention to address at least the above-mentioned problems and/or disadvantages and to provide at least the advantages described below. Accordingly, an aspect of the present invention provides an ESG reception method and apparatus for reducing a waiting time before displaying broadcast data received from a service provider to serve user's convenience in a DVB-H system.

According to one aspect of the present invention, there is provided a method for receiving an Electronic Service Guide (ESG) by a mobile communication terminal in a Digital Video Broadcasting-Handheld (DVB-H) system including a service provider providing a broadcast service and the mobile communication terminal receiving the broadcast service from the service provider. The method includes, upon receipt of a broadcast service request, determining whether a first ESG about the broadcast service has been stored; when the first ESG has been stored, requesting the service provider to first transmit broadcast data among a second ESG and the broadcast data contained in the broadcast service, based on the first ESG; and receiving the broadcast data first from the service provider and displaying the received broadcast data.

According to another aspect of the present invention, there is provided a mobile communication terminal receiving an Electronic Service Guide (ESG) in a Digital Video Broadcasting-Handheld (DVB-H) system including a service provider providing a broadcast service and the mobile communication terminal receiving the broadcast service from the service provider. The mobile communication terminal includes a Radio Frequency (RF) unit for, upon receipt of a broadcast service request, accessing the service provider providing the requested broadcast service, and first receiving broadcast data among a second ESG and the broadcast data contained in the broadcast service from the service provider based on a first ESG for the broadcast service when the first ESG has been stored; a display for displaying the received broadcast data; and a controller for determining whether the first ESG has been stored, and controlling the RF unit to first receive the broadcast data from the service provider based on the first ESG when the first ESG has been stored.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a method for receiving ESG data by a mobile communication terminal according to the prior art;

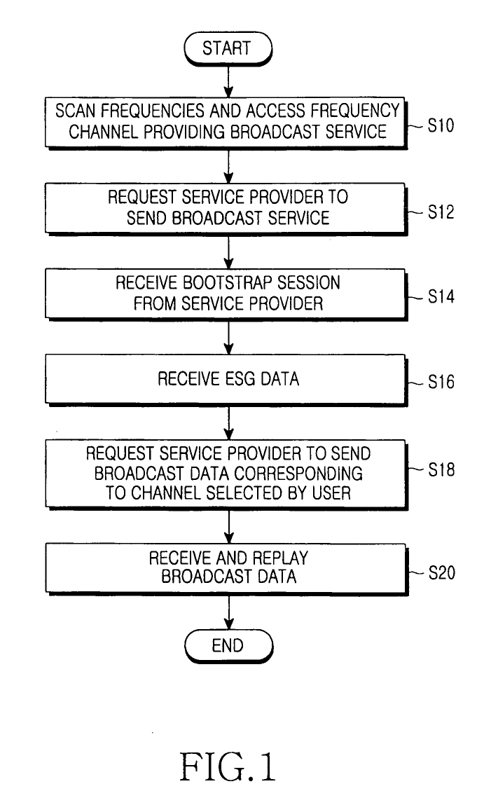

FIG. 2 illustrates a DVB-H system according to an exemplary embodiment of the present invention;

FIG. 3 illustrates a method for receiving ESG data by a mobile communication terminal according to an exemplary embodiment of the present invention; and

FIG. 4 illustrates a method for receiving ESG data by a mobile communication terminal according to another exemplary embodiment of the present invention.

Throughout the drawings, the same drawing reference numerals will be understood to refer to the same elements, features and structures.

### DETAILED DESCRIPTION OF THE INVENTION

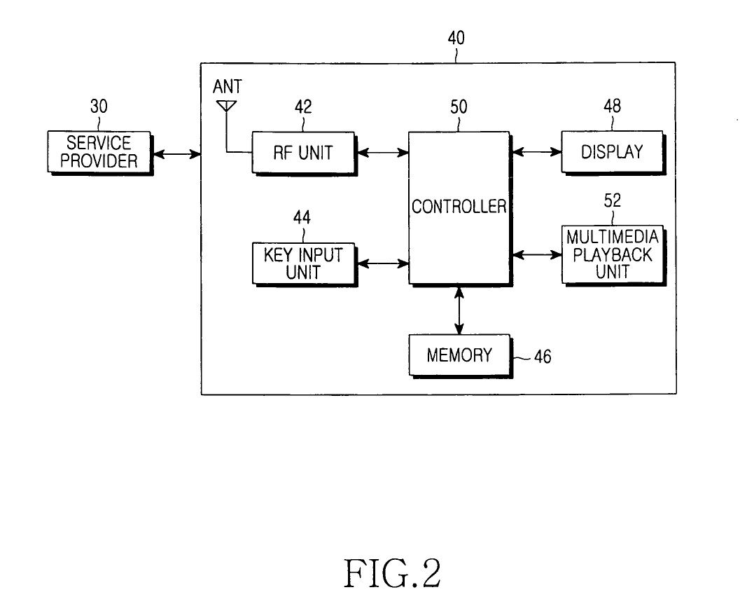

FIGS. 2 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is assumed that a mobile communication terminal according to the present invention has already stored ESG data. In accordance with the present invention, the mobile communication terminal, which has already stored ESG data, first receives and displays broadcast data before the ESG data among two kinds of data (ESG data and broadcast data) included in a broadcast service upon receipt of a user input indicating that the user intends to receive broadcast service associated with the ESG data. That is, the mobile communication terminal can send a broadcast service request to a service provider providing the broadcast service, based on the stored ESG data. The mobile communication terminal may receive and update ESG data received from the service provider while receiving broadcast data.

FIG. 2 illustrates a DVB-H system according to an exemplary embodiment of the present invention.

Referring to FIG. 2, the DVB-H system according to an exemplary embodiment includes at least one service provider 30 and a mobile communication terminal 40.

When the mobile communication terminal 40 requests a broadcast service it desires to access, the service provider 30 sends the broadcast service to the mobile communication terminal 40.

The mobile communication terminal 40 includes a Radio Frequency (RF) unit 42, a key input unit 44, a display 48, a memory 46, a multimedia playback unit 52, and a controller 50.

The RF unit 42 performs a radio communication function of the mobile communication terminal 40. The RF unit 42 includes an RF transmitter (not shown) for up-converting a frequency of a transmission signal and amplifying the up-converted signal, and an RF receiver (not shown) for low-noise-amplifying a received signal and down-converting a frequency of the amplified signal. The RF unit 42 receives broadcast data and ESG data transmitted from the service provider 30.

The key input unit 44 includes keys for inputting numerals and letters, and keys for setting various functions, and receives key inputs from a user. The key input unit 44 can receive a user input selecting a particular broadcast service, for example, a broadcast channel or a broadcast program.

The display 48, which can be composed of a Liquid Crystal Display (LCD) or the like, outputs various display data generated in the mobile communication terminal 40. When LCD is realized in a touch screen, the display 48 may serve as an input means. The display 48 can display broadcast data and/or ESG data received from the service provider 30.

The memory 46 may consist of a program memory and a data memory. A variety of information needed to control an operation of the mobile communication terminal 40 is stored in the memory 46. In accordance with the present invention, the memory 46 may store broadcast data and/or ESG data received from the service provider 30. Further, the memory 46 may update the stored ESG data under control of the controller 50.

The multimedia playback unit 52 plays back multimedia data stored in the memory 46, or received through the RF unit 42. The multimedia playback unit 52, under the control of the controller 50, may play back the broadcast data, i.e., video data and audio data, received from the service provider 30, and display it on the display 46.

The controller 50 controls the overall operation of the mobile communication terminal 40. If the user input received through the key input unit 42 is for reselecting the received broadcast service, the controller 50 controls the mobile communication terminal 40 to access the service provider 30 providing the broadcast service, depending on the ESG data stored in the memory 46.

When the mobile communication terminal 40 accesses the service provider 30 to receive the broadcast service, the controller 50 may control the mobile communication terminal 40 to first receive broadcast data before ESG data. That is, the controller 50 gives priority to broadcast data among ESG data and broadcast data included in the broadcast service, and controls the RF unit 42 to receive the broadcast data first. The controller 50 controls the multimedia playback unit 52 and the display 48 to display the broadcast data for the user.

In this case, the mobile communication terminal 40 can first receive broadcast data before ESG data, thereby contributing to reducing a delay that occurs because it receives broadcast data after receiving the ESG data first, i.e., reducing a waiting time until it displays broadcast data on the display 48.

The controller 50 may compare ESG data stored in the memory 46 with ESG data transmitted from the service provider 30 to determine whether they are the same data. If they are not the same data, for example, if the ESG data provided from the service provider 30 has a later version than the ESG data stored in the memory 46, the controller 50 controls the memory 46 to update the ESG data stored in the memory 46 with the ESG data of a later version.

Conversely, if the user input received through the key input unit 42 is for selecting a new broadcast service rather than the received broadcast program, the controller 50 may control the mobile communication terminal 40 to access the service provider 30 providing the broadcast service. The controller 50 may also control the mobile communication terminal 40 to first receive ESG data from the service provider 30 and display the ESG data.

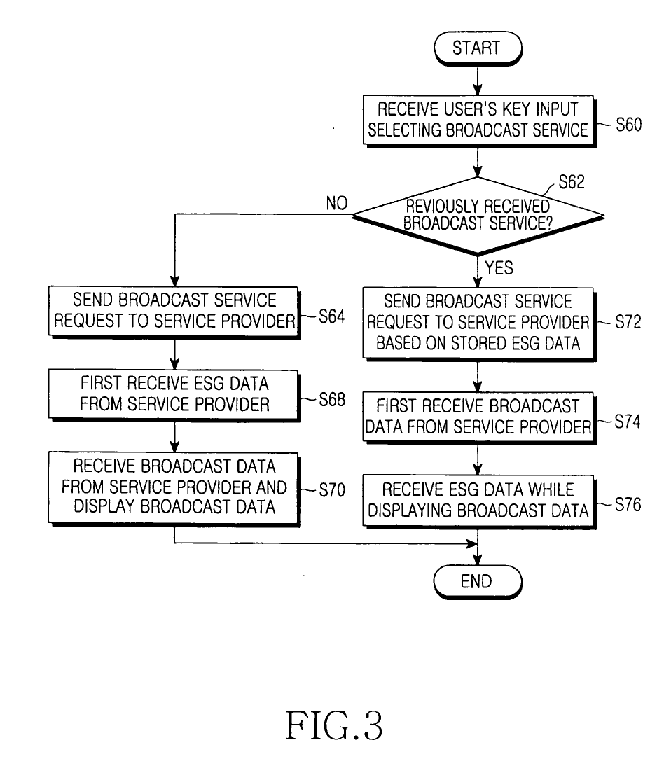

FIG. 3 illustrates a method for receiving ESG data by a mobile communication terminal according to an exemplary embodiment of the present invention.

In step S60, the key input unit 44 of the mobile communication terminal 40 receives a user's key input selecting a broadcast service. In step S62, the controller 50 determines if a broadcast service corresponding to the key input by the user is a previously received broadcast service. For this purpose, the controller 50 may determine if ESG data for the broadcast service has already been stored in the memory 46. If the ESG data has already been stored, the controller 50 may determine that the broadcast service is a previously received broadcast service. If the ESG data has not already been stored, the controller 50 may determine that the broadcast service is not a previously received broadcast service.

If ‘No’ in step S62, the RF unit 42 of the mobile communication terminal 40 requests the service provider 30 to send a broadcast service under the control of the controller 50 in step S64. Upon receiving the broadcast service request from the mobile communication terminal 40, the service provider 30 provides the requested broadcast service to the mobile communication terminal 40. In step S68, the mobile communication terminal 40 first receives ESG data from the service provider 30. Thereafter, in step S70, the mobile communication terminal 40 receives broadcast data from the service provider 30 and displays the received broadcast data.

If ‘Yes’ in step S62, the RF unit 42 in the mobile communication terminal 40 sends, in step S72, a broadcast service requests to the service provider 30 based on ESG data stored in the memory 46 under the control of the controller 50. The mobile communication terminal 40 first receives broadcast data from the service provider 30 in step S74, and then receives ESG data from the service provider 30 while displaying the received broadcast data, in step S76. In this manner, the mobile communication terminal 40 first receives broadcast data and then receives ESG data, thereby reducing the waiting time until it displays the broadcast data on the display 48.

The mobile communication terminal 40 may selectively request ESG data or broadcast data from the service provider 30. That is, the mobile communication terminal 40 may request the service provider 30 to first send broadcast data before ESG data in step S72, and request the service provider 30 to first send ESG data before broadcast data in step S68.

Alternatively, the service provider 30 may selectively send broadcast data or ESG data in response to a request from the mobile communication terminal 40. That is, the service provider 30 can first send broadcast data, if the mobile communication terminal 40 requests the service provider 30 to first transmit the broadcast data before ESG data.

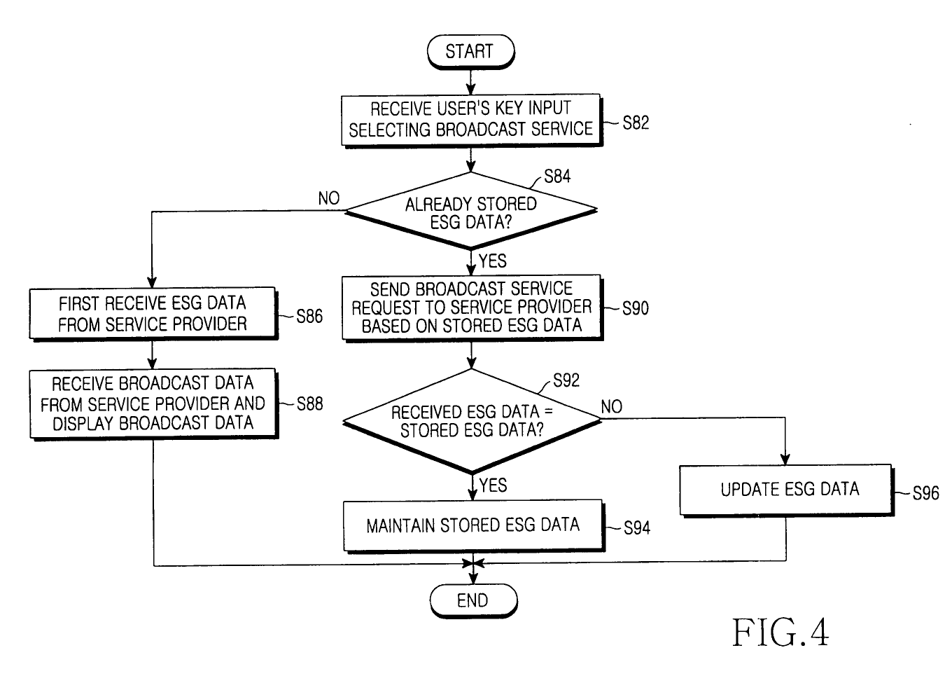

FIG. 4 illustrates a method for receiving ESG data by a mobile communication terminal according to another exemplary embodiment of the present invention.

In step S82, the key input unit 44 of the mobile communication terminal 40 receives a user's key input selecting a broadcast service. In step S84, the controller 50 determines if ESG data for the broadcast service has already been stored in the memory 46.

For example, the controller 50 may determine if ESG data containing the data given in Table 1 has already been stored in the memory 46.

TABLE 1

| Broadcast network | 3G network |
|---|---|
| PID | URL |
| SDP | Charged/Free |
| Broadcast frequency | Content ID |
| Charged/Free | . . . |
| Content ID | |
| . . . | |

Referring to Table 1, data contained in ESG data is different according to a type of the communication network. ESG data for a broadcast network contains Packet IDentification (PID), Session Description Protocol (SDP), Broadcast frequency, Charged/Free, Content ID and the like, while ESG data for a 3^{rd} Generation (3G) network contains Uniform Resource Locator (URL), Charged/Free, Content ID and the like. When the mobile communication terminal 40 delivers the above data to the service provider 30, the mobile communication terminal 40 may receive broadcast data from the service provider 30 without receiving Program Specific Information (PSI)/Service Information (SI) and ESG data needed to receive the broadcast service.

If ‘No’ in step S84, the mobile communication terminal 40 first receives ESG data from the service provider 30 in step S86. Thereafter, in step S88, the mobile communication terminal 40 receives broadcast data from the service provider 30 and displays the received broadcast data.

However, if ‘Yes’ in step S84, the mobile communication terminal 40 requests the service provider 30 to transmit broadcast data based on the stored ESG data in step S90. Then the mobile communication terminal 40 may receive ESG data after first receiving broadcast data.

In step S92, the mobile communication terminal 40 determines if ESG data transmitted from the service provider 30 is identical to the ESG data stored in the memory 46. If ‘No’ in step S92, the mobile communication terminal 40 updates ESG data transmitted from the service provider 30 and stores it in the memory 46 in step S96. However, if ‘Yes’ in step S92, the controller 50 may maintain the stored ESG data in step S94.

When maintaining the ESG data stored in the memory 40 in step S94, the controller 50 may receive no ESG data from the service provider 30.

As is apparent from the foregoing description, the present invention provides an ESG reception method and apparatus for reducing a waiting time before displaying broadcast data received from the service provider by a mobile communication terminal to serve user's convenience in a DVB-H system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for receiving an Electronic Service Guide (ESG) by a mobile communication terminal in a Digital Video Broadcasting-Handheld (DVB-H) system including a service provider providing a broadcast service and the mobile communication terminal receiving the broadcast service from the service provider, the method comprising:
upon receipt of a broadcast service request, determining whether a first ESG about the broadcast service has been stored;
when the first ESG has been stored, requesting the service provider to first transmit broadcast data among a second ESG and the broadcast data contained in the broadcast service, based on the first ESG; and
receiving the broadcast data first from the service provider and displaying the received broadcast data.

2. The method of clam 1, further comprising:
receiving the second ESG from the service provider while displaying the broadcast data.

3. The method of claim 2, further comprising determining whether the second ESG is identical to the first ESG.

4. The method of claim 3, further comprising updating the first ESG with the second ESG when the first and second ESGs are not identical.

5. The method of claim 3, further comprising maintaining the first ESG when the first and second ESGs are identical.

6. The method of claim 1, further comprising first receiving the second ESG before the broadcast data from the service provider when the first ESG has not been stored.

7. A mobile communication terminal receiving an Electronic Service Guide (ESG) in a Digital Video Broadcasting-Handheld (DVB-H) system including a service provider providing a broadcast service and the mobile communication terminal receiving the broadcast service from the service provider, the terminal comprising:
a Radio Frequency (RF) unit for, upon receipt of a broadcast service request, accessing the service provider providing the requested broadcast service, and first receiving broadcast data among a second ESG and the broadcast data contained in the broadcast service from the service provider based on a first ESG for the broadcast service when the first ESG has been stored;
a display for displaying the received broadcast data; and
a controller for determining whether the first ESG has been stored, and controlling the RF unit to first receive the broadcast data from the service provider based on the first ESG when the first ESG has been stored.

8. The mobile communication terminal of claim 7, further comprising a memory for storing the first ESG.

9. The mobile communication terminal of claim 8, wherein the RF unit receives the second ESG from the service provider while displaying the broadcast data.

10. The mobile communication terminal of claim 9, wherein the controller determines whether the second ESG is identical to the first ESG.

11. The mobile communication terminal of claim 10, wherein the controller controls the memory to update the first ESG with the second ESG when the second ESG is not identical to the first ESG.

12. The mobile communication terminal of claim 10, wherein the controller controls the memory to maintain the first ESG when the second ESG is identical to the first ESG.

13. The mobile communication terminal of claim 7, wherein the controller controls the RF unit to first receive the second ESG before the broadcast data from the service provider when the first ESG has not been stored.

14. A wireless communication network comprising a plurality of base stations capable of communicating with a plurality of mobile communication terminals, wherein at least one of the mobile communication terminals is capable of receiving an Electronic Service Guide (ESG) in a Digital Video Broadcasting-Handheld (DVB-H) system including a service provider providing a broadcast service and the mobile communication terminal receiving the broadcast service from the service provider, the mobile communication terminal comprising:
a Radio Frequency (RF) unit for, upon receipt of a broadcast service request, accessing the service provider providing the requested broadcast service, and first receiving broadcast data among a second ESG and the broadcast data contained in the broadcast service from the service provider based on a first ESG for the broadcast service when the first ESG has been stored;
a display for displaying the received broadcast data; and
a controller for determining whether the first ESG has been stored, and controlling the RF unit to first receive the broadcast data from the service provider based on the first ESG when the first ESG has been stored.

15. The network of claim 14, further comprising a memory for storing the first ESG.

16. The network of claim 15, wherein the RF unit receives the second ESG from the service provider while displaying the broadcast data.

17. The network of claim 16, wherein the controller determines whether the second ESG is identical to the first ESG.

18. The network of claim 17, wherein the controller controls the memory to update the first ESG with the second ESG when the second ESG is not identical to the first ESG.

19. The network of claim 17, wherein the controller controls the memory to maintain the first ESG when the second ESG is identical to the first ESG.

20. The network of claim 14, wherein the controller controls the RF unit to first receive the second ESG before the broadcast data from the service provider when the first ESG has not been stored.
